(19) United States
(12) Patent Application Publication
(10) Pub. No.: US 2004/0002304 A1
(43) Pub. Date: Jan. 1, 2004

(54) Receiving apparatus, receiving method, receiving program, recording medium with the program recorded therein and communication system

(75) Inventor: Yutaka Miyahara, Kawagoe-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: PIONEER CORPORATION, Tokyo (JP)

(21) Appl. No.: 10/459,508

(22) Filed: Jun. 12, 2003

(30) Foreign Application Priority Data
Jun. 12, 2002 (JP) 2002-171309

(51) Int. Cl. H04Q 7/20

(52) U.S. Cl. 455/12.1; 455/427

(57) ABSTRACT

When a user carries out an input operation to set a program, the system controller (12) sets the program in response to a signal sent from an input section in response to the input operation. To which of the ensemble A and ensemble B the set program belongs is determined. A surface wave from the earth station or satellite waves from the two artificial satellites are processed according to the necessity according to the ensemble A or B determined by the RF tuner section (13), and are demodulated by the channel decoder (14) to fetch the ensembles A or B and other ensemble B or A for de-interleaving. The different ensembles A or B are simultaneously subjected to the process for de-interleaving, so that the time required for transmitting a program included in other ensembles A and B can be shortened.

### BACKGROUND OF THE INVENTION

1. Field of the Invention

The present invention relates to a receiving apparatus capable of receiving a plurality of groups of information, each of the groups comprising a different type of information, as electric waves in different frequency bands each corresponding to one group of information from an earth station as well as from a plurality of artificial satellites, fetching information belonging to a specific group by demodulating the electric wave according to the necessary, and also fetching a plurality of information included in the group of information, a receiving method, a receiving program, a recording medium with the program recorded therein, and a communication system.

2. Description of Related Art

As a digital broadcasting system for providing, for instance, a number of musical programs, there has been known the digital broadcasting system constructed by XM Satellite Radio Co., or the so-called XM digital broadcasting system. In this XM digital broadcasting system, for instance, all of 100 programs to be provided is divided to two groups each comprising 50 programs. Further the XM digital broadcasting system outputs electric waves in different frequency bands each band corresponding to one group comprising 50 programs from earth stations installed on the ground respectively and two artificial satellites to distribute all of the 100 programs.

In other words, the XM digital broadcasting system outputs electric waves from earth stations and from artificial satellites so that users can access the programs provided by the system not only in major cities but also even in a suburb where there is no earth station. Further the XM digital broadcasting system outputs electric waves in different frequency bands each for one group of 50 programs from two artificial satellites respectively, so that a movable body such as a vehicle can receive the electric waves. With this system configuration, even when a movable body enters an area where an electric wave from one of the satellites can not be received, the movable body can receive an electric wave from the other satellite without fail.

As described above, in the XM digital broadcasting system, electric waves are transmitted in different frequency bands for two groups of programs from two artificial satellites as well as an earth station respectively, and totally electric waves in 6 different frequency bands are utilized. Namely, in the XM digital broadcasting system, of the transmitted electric waves in totally 6 different frequency bands, totally three types of electric waves for one group including a program desired to be heard are received for a user to fetch the desired program. When the user wants to fetch a program belonging to another group, the user receives electric waves in the totally three different frequency bands for the other group.

When switching from a program previously fetched to another program, if the other program belongs to a different group from that including the program previously fetched, it is necessary to receive electric waves in totally three different frequency bands for the other group. In that case, there occurs a time lag of about 4 seconds from a point of time when an electric wave is received from one of the two artificial satellites until a point of time when an electric wave from the other artificial satellite is received. In other words, there are a time interleave between the two artificial satellites. Because of this time interleave, when a user is receiving electric waves only from one of the two artificial satellites and then tries by switching the electric waves to other ones to receive electric waves for another groups of programs including one which the user hopes to hear, about 4 seconds or more time is required from a point of time when the program previously heard by the user is switched to another one now the user wants to hear until a point of time when the new program is outputted, which makes it difficult to improve the convenience in use of the XM digital broadcasting system.

### SUMMARY OF THE INVENTION

A main object of the present invention is to provide a receiving apparatus, a receiving method, and a receiving program which can or make it possible to easily prevent the convenience in use of the XM digital broadcasting system from being lowered due to the time interleave, a recording medium with the program recorded therein, and a communication system.

The receiving apparatus according to the present invention receives a plurality of groups of information, each of the groups comprising a different type of information, as electric waves in different frequency bands each corresponding to one group of information from an earth station as well as from a plurality of artificial satellites respectively, fetches information belonging to a specific group by demodulating the electric wave according to the necessary, and fetches the information included in the fetched group of information, and the receiving apparatus comprises a surface wave fetching section for fetching information included in one of the groups of information by demodulating an electric wave in any one of the frequency bands for the electric waves received from the earth station; a satellite dominant wave fetching section for fetching information included in the same group of information by demodulating an electric wave received from at least one of the artificial satellites in a frequency band for the same groups of information including the information fetched by the surface wave fetching section; and a satellite complementary wave fetching section for receiving information included in the other group of information by demodulating an electric wave received from at least one of the artificial satellites in a frequency band for the other group different from the group including the information fetched by the satellite dominant wave fetching section.

In this invention, information included in any one of groups of information is fetched by demodulating any of electric waves received from an earth station in any one frequency band with the surface wave fetching section. Further, with the satellite dominant wave fetching section, of the electric waves received from at least one of the plurality of artificial satellites, an electric wave in the frequency band corresponding to the same group of information as that fetched by the surface wave fetching section is demodulated to fetch the information included in the same group as that fetched with the surface wave fetching section. Further, with the satellite complementary wave fetching section, of the electric waves received from at least one of the plurality of artificial satellites, an electric wave in a frequency band corresponding to a group of information different from the group including the information fetched by the surface wave fetching section is demodulated to fetch the information included in the other group of information. Because of this configuration, information included in the same group of information can be fetched from the electric waves received from the earth station and the plurality of artificial satellites, so that it is possible to fetch a plurality of information included in a plurality of groups of information without fail even in an area where an electric wave from an earth station does not reach and can not be received or in an area where an electric wave from an artificial satellite is shielded and can not be received. Further as information included in another group of information other than that to be fetched is fetched, even when a frequency band to be demodulated is changed to another one for another group of information, the time lag in fetching information due to the time interleave between electric waves outputted from a plurality of artificial satellites is shortened, which improves the convenience in use of the XM digital broadcasting system.

In this invention, the receiving apparatus may be installed in a movable body which can move, and the satellite dominant wave fetching section preferably fetches information included in the same group of information as that including the information fetched by the surface wave fetching section based on the electric waves received from at least two or more artificial satellites among a plurality of artificial satellites.

The receiving apparatus according to the present invention can be installed in a movable body which can move, and when information included in the same group as that including the information fetched by the surface wave fetching section is to be fetched, the information is fetched based on the electric waves transmitted from at least two or more of the plurality of artificial satellites. Because of this feature, information included in the same group of information is fetched based on the electric waves from two or more artificial satellites, so that fluctuation of the electric field is prevented when the electric waves are received by a movable body, which makes it possible to stably fetch information included in a desired group of information without fail.

The present invention is based on the configuration in which the receiving apparatus can not be moved at least while it receives and demodulates an electric wave, and the satellite dominant wave fetching section preferably fetches information included in the same group of information as that including the information fetched by the surface wave fetching section based on the electric waves received by either one of the plurality of artificial satellites.

The present invention is based on the configuration in which the receiving apparatus can not be moved at least while it receives and demodulates an electric wave, when information included in the same group as that including information fetched by the surface wave fetching section is fetched with the satellite dominant wave fetching section, the information is fetched based on the electric waves received from either one of the plurality of artificial satellites. Because of this feature, in the configuration in which electric waves are always received while the receiving apparatus is not moving and fixed at a point, fluctuation of the electric field does not occur, so that only the configuration making it possible to fetch a group of information based on electric waves transmitted from one artificial satellite is required, which enables simplification of the system configuration.

The receiving apparatus according to the present invention comprises a tuner section comprising a surface wave filter for attenuating signals in frequency bands other than that for a group of information to be fetched in electric waves received from an earth station, a satellite dominant wave filter for attenuating signals in frequency bands other than that for the group of information to be fetched in the electric waves received from at least one of the artificial satellites, and a satellite complementary wave filter for attenuating signals in frequency bands for groups of information other than that to be fetched in the electric waves received from the plurality of artificial satellites, and the receiving apparatus has preferably the configuration in which the surface wave fetching section fetches a group of information by demodulating signals processed by the surface wave filter in the tuner section, the satellite dominant wave fetching section fetches the group of information by demodulating the signals processed by the satellite document wave filter in the tuner section, and the satellite complementary wave fetching section fetched groups of information other than the fetched groups of information by demodulating the signals by the satellite complementary filter in the tuner section.

In the present invention, signals in frequency bands other than that for the group of information to be fetched in the electric waves received by the surface wave fetching section in the tuner section from the earth station are attenuated by the surface wave filter section, and the signals fetched after the attenuation processing are demodulated to fetch the group of information to be fetched. Further signals in frequency bands other than that for the group of information to be fetched in the electric waves received by the satellite dominant wave fetching section from the earth station are attenuated by the satellite dominant wave filter in the tuner section, and the signals fetched after the attenuation processing are demodulated to fetch the group of information to be fetched. Further signals in frequency bands for groups of information other than that for the group of information to be fetched in the electric waves received from at least either one of the plurality of artificial satellites are attenuated by the satellite complementary filter in the tuner section, and information included in the groups of information other than that including the information to be fetched is fetched by demodulating the signals after the attenuation. Because of this configuration, by setting a frequency band for signals to be attenuated in the tuner section, a group or groups of information can be specified, so that not only a group of information to be fetched, but also information in other groups of information can easily be fetched with the simple configuration for preventing troubles caused by the time interleave.

The receiving apparatus according to the present invention preferably comprises a setting section for setting a group of information, and a switching section for switching a frequency band, signals in which are to be demodulated in signals received from the earth station and a plurality of artificial satellites corresponding to a group of information set in the setting section.

In this invention, in response to the group of information set in the setting section, a frequency band, signals in which are to be demodulated, in the electric waves received from the earth station and the plurality of artificial satellites is switched. Because of this configuration, a group of information to be fetched is selected by switching in the switching section in response to the setting in the setting section, and not only information included in a group of information to be fetched, but also information included in other groups of information can easily be fetched for preventing the time interleave.

In the present invention, the receiving apparatus preferably correspond to two artificial satellites and two groups of information.

This invention is especially adapted to the configuration in which two artificial satellites are used and information included in either one of the two groups of information is fetched.

The receiving apparatus according to the present invention preferably comprises a receiving section for receiving a first broadcast, a second broadcast, and a third broadcast, each of which broadcasts first information with a different frequency band respectively, and a fourth broadcast, a fifth broadcast, and a sixth broadcast, each of which broadcasts information with the contents different from those of the first information with a different frequency band respectively; a first demodulating section for demodulating signals for the first broadcast and the fourth broadcast; a second demodulating section for demodulating the second broadcast and the fifth broadcast; and a third demodulating section for demodulating the third broadcast and the sixth broadcast, and the first, second, and third demodulation sections execute demodulation simultaneously, the third demodulating section demodulates the sixth broadcast when the second demodulating section demodulated the second broadcast, while the third demodulating section demodulates the third broadcast when the second demodulating section demodulates the fifth broadcast.

In this invention, the first broadcast, second broadcast, and third broadcast, each of which broadcasts the first information in a different frequency band respectively, and the fourth broadcast, fifth broadcast, and sixth broadcast, each of which broadcasts second information with the contents different from those of the first information with a different frequency band respectively, are received by the receiving section. Then demodulation of signals for the first broadcast of the first information and those for the fourth broadcast of the second information by the first demodulating section, demodulation of signals for the second broadcast of the first information and those for the fifth broadcast of the second information by the second demodulating section, and demodulation of the third broadcast of the first information and the sixth broadcast of the second information are executed simultaneously. In this step of demodulation, when the second demodulating section demodulates the second broadcast of the first information, the sixth broadcast of the second information is demodulated by the third demodulating section, and when the second demodulating section demodulates the fifth broadcast of the second information, the third broadcast of the first information is demodulated by the third demodulating section. Because of this configuration, the first information and second information are fetched by means of demodulation with the first demodulation section, and when the first information or the second information is to be fetched by the second demodulation section, the second information or the first information is fetched by the third demodulation section, the first information and the second information are fetched at least through two broadcasts in different frequency bands, which makes it possible to fetch information without fail and shorten the time lag in fetching information due to the time interleave and further improves the convenience in use.

The receiving apparatus according to the present invention preferably comprises a selecting section for selecting, in the environment in which each of the first information and the second information includes a group including a plurality of programs for broadcasting respectively, one program from the plurality of programs included in the first information and the second information; a switching section for selecting the first demodulating section or one of the second demodulation section and the third demodulation section, according to the receiving conditions; and an extracting section for outputting and transmitting the one program selected by the selecting section.

In this invention, which of the output from the second demodulation section or the third demodulation section and output from the first demodulation section is to be fetched is selected and switched by the switching section according to the receiving conditions, and either one program selected from the groups of programs included in the first information and the second information respectively is extracted for output by the extracting section. Because of this configuration, even when there are a plurality of information concerning a plurality of groups each including a plurality of programs, it is possible to fetch a desired program or programs without fail and also to shorten the time lag in fetching the information due to the time interleave.

The receiving apparatus according to the present invention is preferably based on the configuration in which, the extracting section extracts output from the either one demodulating section, which demodulates said second information, of the second demodulation section and the third demodulation section, and the first demodulating section demodulates the fourth broadcast and at the same time demodulation by one demodulating section, which demodulates said first information, of said second demodulating section and said third demodulating section is maintained, in a case said selecting section makes a selection for said extracting section to extract one program included in said second information while said extracting section is extracting another program included in said first information.

In this invention, when one program included in the first information is being extracted by the extracting section, if a selection is made by the selecting section so that another one program included in the second information is extracted, output from the second demodulation section or the third demodulation section either one currently demodulating the second information is fetched by the extracting section. Further the fourth broadcast of the second information is demodulated by the first demodulation section, and demodulation of the second demodulation section or the third demodulation section either one currently demodulating the first information is continued. Because of this configuration, when switching between the first information and second information is to be made according to a program desired to be fetched, controls are provided so that not only the information including the desired, but also different information are fetched, and therefore the desired program can be fetched without fail with the time lag in fetching information due to the time interleave caused by switching reduced.

The receiving apparatus according to the present invention preferably comprises a receiving section for receiving a first broadcast, a second broadcast, and a third broadcast each broadcasting the first information in a different frequency band respectively, and further receiving a fourth broadcast, a fifth broadcast, and a sixth broadcast each broadcasting the second information with the contents different from those of the first information in a different frequency band respectively; a first demodulation section for demodulating the first broadcast and the fourth broadcast; a second demodulation section for demodulating the second broadcast and the third broadcast; and the third demodulation section for demodulating the fifth broadcast and the sixth broadcast, and the first demodulation section, second demodulation section, and third demodulation section preferably execute demodulation simultaneously.

In this invention, the first broadcast, second broadcast, and third broadcast each broadcasting the first information in a different frequency band respectively, and the fourth broadcast, fifth broadcast, and fifth broadcast each broadcasting the second information with the contents different from those of the first information in a different frequency band respectively are received by the receiving section. Demodulation of the first broadcast of the first information and the fourth broadcast of the second information by the first demodulation section, demodulation of the second broadcast and the third broadcast each of the first information by the second demodulation section, and demodulation of the fifth broadcast and the sixth broadcast each of the second information by the third demodulating section are carried out simultaneously. Because of this configuration, the first information and second information can be fetched by means of demodulation with the first demodulation section, and further the first information is fetched by the second demodulation section and the second information by the third demodulation section, so that the first information and the second information are fetched through at least two broadcasts in different frequency bands respectively, which makes it possible to fetch desired information without fail with the time lag in fetching information due to the time interleave reduced and improves the convenience in use.

The receiving apparatus according to the present invention preferably comprises a selecting section for selecting, in the environment in which each of the first information and the second information includes a group including a plurality of programs for broadcasting respectively, one program from the plurality of programs included in the first information and the second information; a switching section for selecting one broadcast, which is demodulated by said second demodulating section and said third demodulating section respectively, from said first broadcast and said second broadcast, and for selecting said first demodulating section or one demodulating section of said second demodulating section and said third demodulating section, according to the receiving conditions; and an extracting section for extracting and outputting the one program selected by the selecting section.

In this invention, to fetch one program included in a group of programs in the first information and another one program included in a group of programs in the second information, which broadcasts should be demodulated by the second demodulation section and the third demodulation section is selected and switched by the switching section according to the receiving conditions. Further which of output from the second demodulation section or the third demodulation section and output from the first demodulation section is to be fetched is selected and switched by the switching section according to the receiving conditions. Then the programs selected by the selecting section are extracted and outputted by the extracting section. Because of this configuration, even there are a plurality of information for groups of programs each including a plurality of programs, it is possible to fetch desired programs without fail with the time lag in fetching the information due to the time interleave shortened.

The receiving apparatus according to the present invention is preferably based on the configuration in which, said extracting section extracts output from said third demodulating section, said first demodulating section demodulates said fourth broadcast, and demodulation of said second broadcast or third broadcast by said second demodulating section is maintained, in a case said selecting section makes a selection for said extracting section to extract one program included in said second information while said extracting section is extracting another program included in said first information.

In this invention, when the extracting section is extracting one program included in the first information, if the selecting section makes a selection so that another one program included in the second information is extracted, the extracting section fetches output from the third demodulation section demodulating the second information. Further the fourth broadcast of the second information is demodulated by the first demodulation section, and demodulation of the second broadcast and the third broadcast each broadcasting the first information by the second demodulation section is continued. Because of this configuration, even when switching between the first information and the second information is to be made according to a program to be fetched, controls are provided so that not only the information including the desired program, but also different information are fetched, so that it is possible to fetch the desired program with the time lag in fetching information due to the time interleave caused by switching reduced.

The receiving method according to the present invention has been developed for and is applicable to the receiving apparatus according to the present invention described above, and in this receiving method, groups of information each group including different information are received as electric waves in different frequency bands each band corresponding to each group of information from an earth station and a plurality of artificial satellites respectively, and the information included in the fetched group is fetched, and this receiving method is characterized in that either one of the groups of information is fetched by demodulating either one of signals in one frequency band among the electric waves received from the earth station, signals in the frequency band corresponding to the same group of information as that fetched from the electric wave received from the earth station among the electric waves received from at least one of the plurality of artificial satellites are demodulated to fetch the information included in the same group of information, and signals in the frequency bands corresponding to other groups of information other than the group of information fetched from the electric waves received from the earth station among the electric waves received from the one artificial satellite are demodulated to fetch information included in the other groups of information.

The receiving method according to the present invention can be modified according to variant of the receiving apparatus according to the present invention.

Because of this feature, in the receiving method according to the present invention, the same actions and effects as those provided by the receiving apparatus according to the present invention can be provided.

A receiving program according to the present invention makes a computing section execute the receiving method according to the present invention described above.

In this invention, for instance, the receiving method described above can be executed by the computing section by using and installing, for instance, a multi-purpose computer as the computing section, and further convenience in application of the present invention is substantially improved.

The receiving program according to the present invention described above is recorded in a recording medium according to the present invention so that the receiving program can be read out by the computing means.

The receiving program according to the present invention for having the receiving method according to the present invention executed can be recorded in a recording medium. Because of this feature, treatment of the receiving program is easy, which substantially improves the convenience in use thereof.

A communication system according to the present invention comprises an earth station transmitting a plurality of groups of information each including a plurality of different information as electric waves in different frequency bands corresponding to the plurality of groups of information, a plurality of artificial satellites transmitting the plurality of groups of information as electric waves in different frequency bands corresponding to the plurality of groups of information respectively, and a receiving apparatus.

In this invention, the receiving apparatus according to the present invention as described above is used, so that the time lag in fetching information from electric waves transmitted from a plurality of artificial satellites due to the time interleave can be shortened, which improves the convenience in use thereof. Because of this feature, the communication for fetching a plurality of information included in a plurality of groups of information can smoothly be performed regardless of the environmental conditions.

### BRIEF DESCRIPTION OF THE DRAWINGS

FIG. 1 is a block diagram showing general configuration of a communication system according to a first embodiment of the present invention;

FIG. 2 is a conceptual diagram showing the state of electric waves transmitted from or received by the communication system according to the first embodiment;

FIG. 3 is a block diagram showing general configuration of a receiving apparatus according to the first embodiment of the present invention;

FIG. 4 is an explanatory view showing operations for processing electric waves received by the receiving apparatus in the first embodiment of the present invention;

FIG. 5 is a flow chart showing operations for fetching program information by the receiving apparatus in the first embodiment;

FIG. 6 is a flow chart showing operations for switching information for a program to that for another program by the receiving apparatus according to the first embodiment;

FIG. 7 is a block diagram showing general configuration of a receiving apparatus according to a second embodiment of the present invention;

FIG. 8 is a flow chart showing operations for fetching information for a program with the receiving apparatus according to the second embodiment;

FIG. 9 is a block diagram showing general configuration of a receiving apparatus according to a third embodiment of the present invention; and

FIG. 10 is a block diagram showing general configuration of a receiving apparatus according to a fourth embodiment of the present invention.

### DETAILED DESCRIPTION OF PREFERRED EMBODIMENT(S)

Embodiments of the communication system according to the present invention are described in detail with reference to the related drawings.

### FIRST EMBODIMENTS

### Configuration of the Communication System

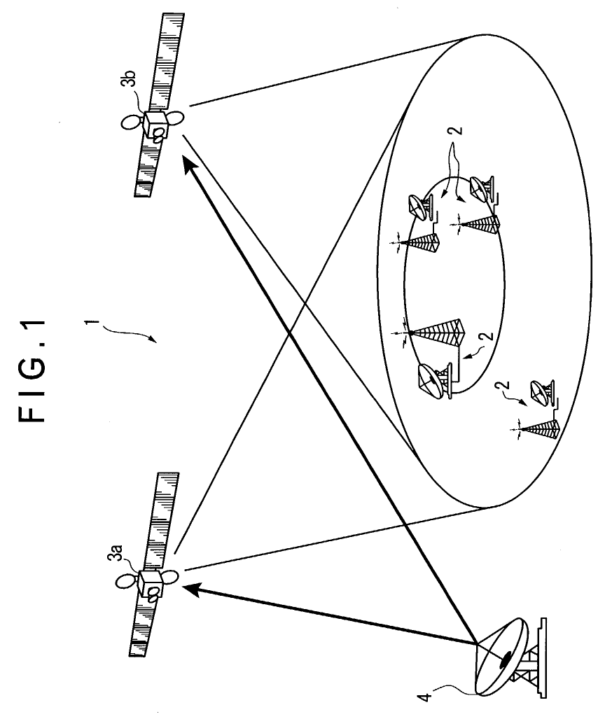

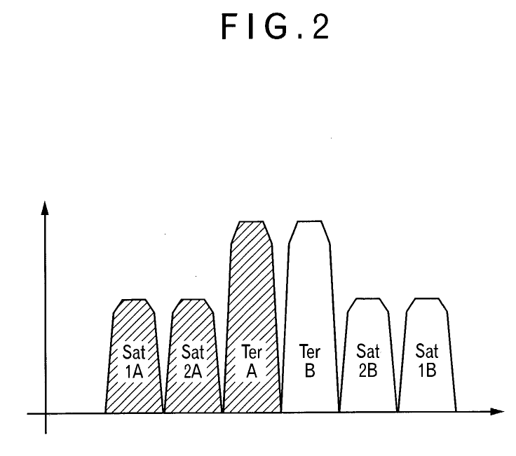

FIG. 1 is a pattern diagram showing general configuration of one embodiment of the communication system according to the present invention. FIG. 2 is a conceptual diagram showing the state of electric waves transmitted from or received by the communication system.

In FIG. 1, the reference numeral 1 indicates a communication system, and this communication system 1 is a system used for broadcasting a plurality of information such as, for instance, a plurality of musical programs or news programs in a wide area so that the programs can be received at terminals. The communication system 1 comprises an earth station 2, a plurality of (for instance, two) artificial satellites 3a, 3b, and a receiving apparatus which is a terminal described hereinafter.

The earth station 2 fetches electric waves transmitted from a base station 4 directly or via the artificial satellites 3a, 3b. The earth station 2 subjects the fetched electric waves to such processing as amplification or conversion according to the necessity, and outputs a plurality of broadcasts, for instance, two types of broadcasts, the first broadcast in the frequency band Ter A and the fourth broadcast in the frequency band Ter B as surface waves as shown in FIG. 2. In other words, a plurality of programs such as musical programs and news programs are provided in different frequency bands respectively with a prespecified frequency space. Because of this feature, when 100 or more programs are to be provided, the frequency range becomes excessively large, which is a large load for signal transmission and receiving. To overcome this problem, the plurality of programs are grouped, for instance, into an ensemble A with 50 programs which is the first information described above and an ensemble B with 50 programs which is the second information, and the ensembles A and B are transmitted as surface waves in different frequency bands respectively.

Each of artificial satellites 3a, 3b fetches electric waves from the base station 4, processes the electric waves according to the necessity, and outputs two types of signals, namely those in the frequency band Sat I(2) A for the second (third) broadcast and those in the frequency band Sat I(2) B, Sat I (2) A and Sat I(2) B different from each other and also different from the frequency bands TerA and TerB respectively as satellite waves. In other words, like in the case of the surface waves described above, also the electric waves transmitted from each of the artificial satellites 3a, 3b are transmitted as satellite waves in the two frequency bands Sat I(2)A and Sat I(2)B corresponding to the ensembles A and B respectively.

### Configuration of the Receiving Apparatus

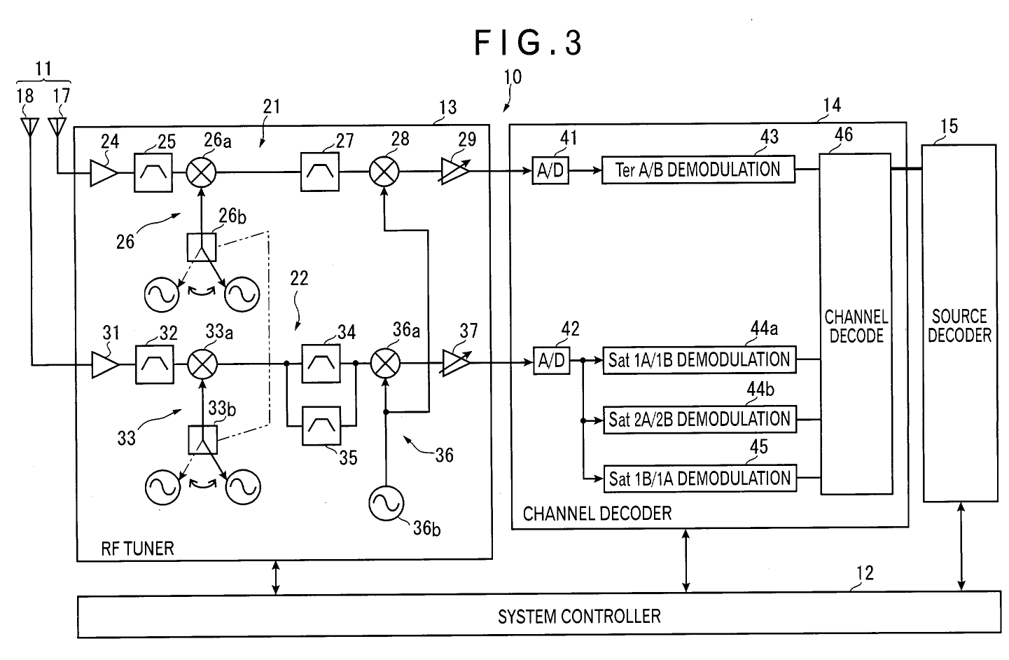

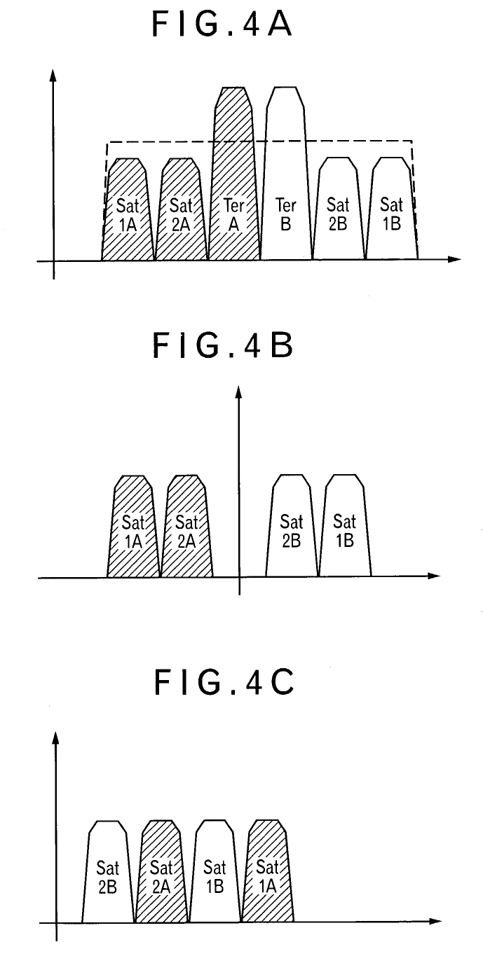

Configuration of the receiving apparatus is described below with reference to the related drawings. FIG. 3 is a block diagram showing the receiving apparatus according to one this embodiment of the present invention. FIG. 4 is an explanatory view showing operating for processing electric waves received by this receiving apparatus.

In FIG. 3, the deference numeral 10 indicates a receiving apparatus, and this receiving apparatus 10 is mounted for use, for instance, on a vehicle like a car as a movable body not shown in the figure. The receiving apparatus 10 comprises a receiving antenna 11, an input section as a selecting section not shown, a system controller 12, an RF tuner section 13 as a receiving section, a channel decoder 14, and a source decoder 15.

The receiving antenna 11 comprises a surface wave antenna 17 for receiving a surface wave, and a satellite wave antenna 18 for receiving a satellite wave.

The input section has, for instance, buttons and switches (not shown) operated by a user. The input section outputs specified signals to the system controller 12 in response to input operations of the buttons and switches. In response to the operations, for instance, operations of the entire receiving apparatus 10 are set, for instance, for setting a specified program which the user hopes to fetch and enjoy. The operating of the input section are not always performed with a button or a switch, and any method including input with voices is allowable.

The system controller 12 controls operations of the receiving apparatus 10 as a whole. Further the system controller 12 outputs the fetched information to an output device not shown herein and connected to the receiving apparatus 10, and the output device outputs the information as, for instance, voices and sounds, or images.

The RF tuner section 13 comprises a surface wave tuner section 21 and a satellite wave tuner 22. The surface wave tuner 21 is connected to the surface wave antenna 17. The satellite wave tuner section 22 is connected to the satellite wave antenna 18.

The surface wave tuner section 21 comprises a first surface wave amplifying circuit 24, a first surface wave filter 25, a first surface wave frequency converting circuit 26 as a switching section, a second surface wave filter 27 as a surface filter, a second surface wave frequency converting circuit 28, and a second surface wave amplifying circuit 29.

The first surface wave amplifying circuit 24 amplifies the electric waves received by the surface wave antenna 17.

The first surface wave filter 25 executes the processing for attenuating, among the signals amplified by the first surface wave amplifying circuit 24, those other than the signals in the frequency bands of the signals transmitted from the earth station 2. The frequency bands of the attenuated signals are within the range of the frequency bands TerA and TerB for the two ensembles A and B.

The first surface wave converting circuit 26 converts the signals fetched through the attenuation by the first surface wave filter 25 to those in a prespecified intermediate frequency band. This first surface wave frequency converting circuit 26 comprises a first surface wave mixing circuit 26a and a first surface wave local oscillating circuit 26b. The first surface wave mixing circuit 26a efficiently converts high frequency signals to intermediate frequency signals to reduce noises. The first surface wave local oscillating circuit 26b is a clamping circuit with high stability based on the Colpittz oscillator which is stable and has the simple circuit configuration. The first surface wave oscillating circuit 26b controls the first surface wave mixing circuit 26a by switching between the two different first local oscillation frequencies so that the intermediate frequency waves are stabilized. This switching between the first local oscillation frequencies is executed by the system controller 12 based on a signal transmitted from the input section in response to an input operation by the user. More specifically, switching between the ensemble A and ensemble B is carried out in response to an input operation by the user.

The second surface wave filter 27 executes the processing for attenuating signals other than those in the frequency bands corresponding to either one of the ensembles A and B. Namely, the second surface wave filter 27 fetches either one of the ensemble A in the frequency band TerA or the ensemble B in the frequency band TerB. The frequency bands TerA and TerB, in which signals are attenuated by the second surface wave filter 27, are set in correspondence to the ensembles A and B under controls by the system controller 12 having recognized the ensembles A and B set in the input section.

Further the second surface wave frequency converting circuit 28 converts the signals fetched by the second surface wave filter 27 to prespecified intermediate frequency waves.

The second surface wave amplifying circuit 29 has a volume not shown in the figure. This second surface wave amplifying circuit 29 amplifies the signals converted by the second surface wave frequency converting circuit 28 to prespecified intermediate frequency signals.

The surface wave tuner section 21 outputs the signals received by the surface wave antenna 17 to the channel decoder 14 as prespecified signals corresponding to the ensembles A and B set in the input section.

On the other hand, the satellite wave tuner section 22 comprises a first satellite wave amplifying circuit 31, a first satellite wave filter 32, a first satellite wave frequency converting circuit 33 as a switching section, a second satellite wave filter 34 as a satellite dominant wave filter, and a third satellite wave filter 35 as a satellite complementary wave filter, a second satellite wave frequency converting circuit 36, and a second satellite wave amplifying circuit 37.

The first satellite wave amplifying circuit 31 amplifies the electric waves received by the satellite wave antenna 18.

The first satellite wave filter 32 executes the processing for signals other than those in the frequency bands for signals transmitted from the artificial satellites 3a, 3b. The frequency bands, in which the signals are attenuated, are within the range of the two frequency bands Sat1 (2) A and Sat1 (2) corresponding to the two ensembles A and B transmitted from the two artificial satellites 3a, 3b. Namely, the range is the block surrounded by the dotted line in FIG. 4A.

The first satellite wave frequency converting circuit 33 converts the signals fetched by the processing for attenuation by the first satellite wave filter 32 to prespecified intermediate frequency signals. This first satellite wave frequency converting circuit 33 comprises a first satellite wave mixing circuit 33a and a first satellite wave local oscillating circuit 33b. The first satellite wave mixing circuit 33a efficiently converts high frequency waves to intermediate frequency waves to reduce noises. The first satellite wave local oscillating circuit 33b is a clamping circuit with high stability based on the Colpittz oscillator which is stable and has the simple circuit configuration. The first satellite wave local oscillating circuit 33b carries out switching between the two different first local oscillation frequencies so that the intermediate frequency signals are stabilized to control the first satellite wave mixing circuit 33a. Switching between the first local oscillation frequencies is executed by the system controller 12 based on the signals transmitted from the input section in response to an input operation by the user. This switching is executed in correlation to the first surface wave frequency converting circuit 26.

The second satellite wave filter 34 executes the processing for attenuating signals other than those in the frequency bands corresponding to the ensembles A and B set in the input section. Namely, the second satellite wave filter 34 fetches the ensemble A in the frequency band Sat 1(2) A and the ensemble B in the frequency band Sat 1(2) B, the Sat 1(2) A and Sat 1(2) B identical to those for the ensembles A and B transmitted from the two artificial satellites 3a and 3b and fetched by the second surface wave filter 27 respectively. The Sat 1(2) A and Sat 1(2) B are set to the set ensembles A and B under controls by the system controller 12 having recognized the ensembles A and B set in the input section.

This third satellite wave filter 35 executes the processing for attenuating signals other than those in ensembles B and A other than the ensembles A and B set in the input section. In other words, the third satellite filter 35 fetches the ensemble B in the in the frequency band Sat 1(2) B or the ensemble A in the frequency band Sat 1(2) A corresponding to the ensembles B and A different from the ensembles A and B for signals transmitted from the two artificial satellites 3a and 3B and fetched through the second surface wave filter 27. Also this third satellite wave filter 35 is controlled by the system controller 12 like the second satellite wave filter 34. The waveform as shown in FIG. 4A is converted to that as shown in FIG. 4B by the second satellite wave filter 34 and the third satellite wave filter 35.

The second satellite wave frequency converting circuit 36 converts the signals fetched by the second satellite wave filter 34 and the third satellite wave filter 35 to prespecified intermediate frequency signals. This second satellite wave frequency converting circuit 36 has a second satellite wave mixing circuit 36a and a second satellite wave local oscillating circuit 36b. The second satellite wave mixing circuit 36a efficiently converts the signals, like the first satellite wave mixing circuit 33a, to prespecified signals to reduce noises. The second satellite wave local oscillating circuit 36b is controlled so that the oscillation frequency is stabilized at a constant level according to a reference frequency not shown herein. The waveform as shown in FIG. 4B is converted to that as shown in FIG. 4C by this second satellite wave frequency converting circuit 36.

The second satellite wave amplifying circuit 37 has a volume not shown herein. This second satellite wave amplifying circuit 37 amplifies the signals converted in the second satellite wave frequency converting circuit 36 to prespecified intermediate frequency signals.

The satellite wave tuner section 22 outputs the signals received with the satellite wave antenna 18 to the channel decoder 14 as prespecified signals corresponding to one of the ensembles A and B set in the input section and also the other ensembles B and B.

The channel decoder 14 comprises A/D (analog/digital) converters 41, 42, a surface wave demodulating section 43 which is a first demodulating section as a surface wave fetching section, satellite dominant demodulating sections 44a, 44b which are second demodulating sections as two satellite dominant fetching sections, a satellite complementary wave demodulating section 45 which is a third demodulating section as a satellite complementary wave as a satellite complementary wave fetching section, and a channel decoding section 46 as an extracting section.

The A/D converter 41 is connected to the surface wave tuner section 21. This A/D converter 41 converts the signals fetched by the surface wave tuner section 21 to digital signals according to the necessity. The converted signals are transmitted to the surface wave demodulating section 43.

The A/D converter 42 is connected to the satellite wave tuner section 22. This A/D converter 42 converts signals fetched by the satellite wave tuner section 22 to digital signals according to the necessity. The converted digital signals are transmitted to the satellite dominant wave demodulating sections 44a, 44b and to the satellite complementary wave demodulating section 45.

The surface wave demodulating section 43 fetches the ensembles A, B by demodulating the digital signals converted by the A/D converter 41. This surface wave demodulating section 43 is controlled by the system controller 12 having set the ensembles A and B according to signals from the input section in response to an input operation by the user. With this control, the surface wave demodulating section 43 demodulates either one of the ensembles A, B set in the input section and fetched through the attenuation by the surface wave tuner section 21. Either one of the ensembles A, B demodulated as described above is transmitted to the channel decoding section 46.

The two satellite dominant wave demodulating sections 44a, 44b correspond to the artificial satellites 3a, 3b, demodulates the digital signals converted by the A/D converter 42, and fetches the ensembles A, B. In other words, these satellite dominant wave demodulating sections 44a, 44b fetch the same ensembles A and B as the ensembles A and B which are included in the digital signals transmitted from the artificial satellites 3a, 3b and fetched by the surface wave demodulating section 43. The ensembles A and B fetched by the satellite dominant wave demodulating sections 44a, 44b are controlled by the system controller 12 as well as by the surface wave demodulating section 43. In other words, the same ensembles A and B as the ensembles A and B fetched by the surface wave demodulating section 43 are selectively fetched. The signals for these demodulated ensembles A and B are transmitted to the channel decoder section 46.

The satellite complementary wave demodulating section 45 corresponds to either one of the two artificial satellites 3a, 3b, demodulates digital signals converted by the A/D converter 42, and fetches the ensembles B and A. In other words, the satellite complementary wave demodulating section 45 fetches other ensembles B and A which are the ensembles A and B included in the digital signals and transmitted from either one of the two artificial satellites 3a, 3b, and also which are not the ensembles A and B fetched by the surface wave demodulating section 43. This satellite complementary wave demodulating section 45 selectively fetches the other ensembles B and A under controls by the system controller 12 having recognized the setting in the input section. The demodulated other ensembles B and A are transmitted to the channel decoding section 46.

The channel decoding section 46 decodes the signals transmitted from the surface wave demodulating section 43, two satellite dominant demodulating sections 44a, 44b, and satellite complementary wave demodulating section 45. In other words, the time lag between the ensembles A and B obtained through the demodulation, the so-called time interleave is subjected to the so-called de-interleaving. The channel decoding section 46 generates information for the programs transmitted from the earth station 2 and the artificial satellites 3a, 3b by means of de-interleaving.

On the other hand, the source decoder 15 is controlled by the system controller 12, and generates information for all of the programs, the so-called program table information based on the information for each program from the channel decoding section 46 in the channel decoder 14.

### Operations of the Communication System

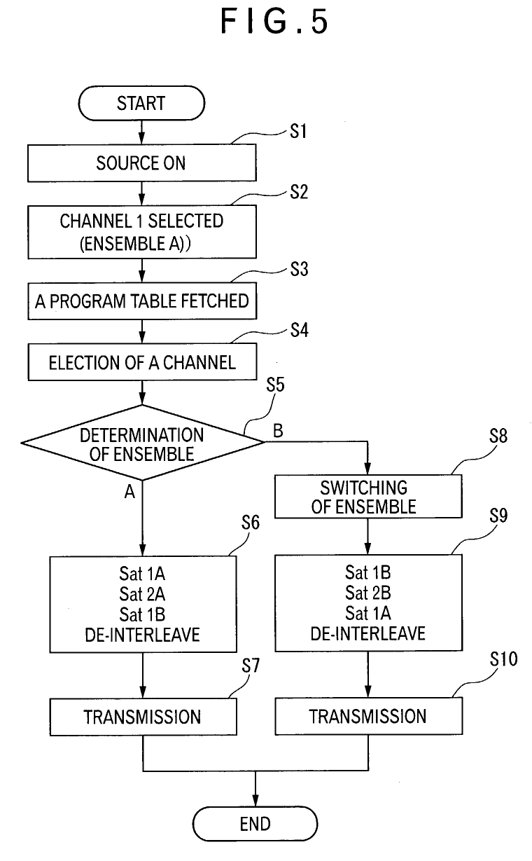

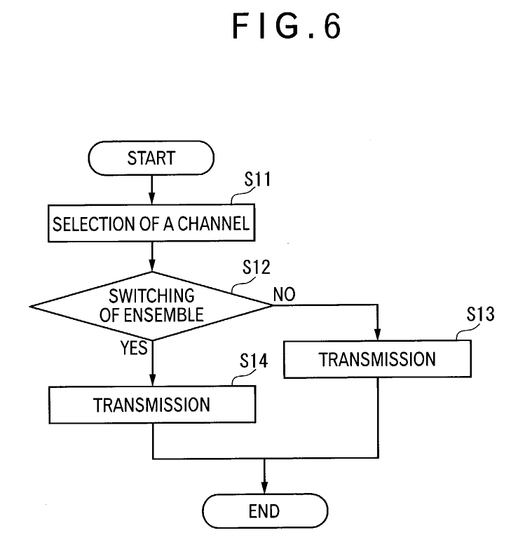

Next, operations for transmitting and receiving information in the communication system according to the embodiment described above are described with reference to the drawings. FIG. 5 is a flow chart showing operations for fetching program information in the receiving apparatus. FIG. 6 is a flow chart showing operations for switching to other program information in the receiving apparatus.

When a power supply is turned on by a user and power is supplied (step 1), the system controller 12 sets one channel 1 included in the ensemble A for first program information, namely program table information (step 2). Further the system controller 12 receives electric waves transmitted from the earth station 2 and from the artificial satellites 3a, 3b and fetches signals for a one channel with the RF tuner section 13. Then the system controller 12 demodulates the fetched signals with the channel decoder 14 to fetch the program table information for a one channel (step S3). The fetched program table information is stored in a storing section of the system controller 12.

Then, the system controller 12 determines whether an input operation has been done by a user in the input section to select and set a specific program or not. When the system controller 12 determines that any specific program has not been set, the system controller 12 sets any program stored in a storing section such as an incorporated memory or the like not shown and provided in the system controller 12. The program stored in this storing section is, for instance, information for the last program set just before the power supply is turned off. When the system controller 12 determines that a specific program has been set, the system controller 12 sets the program. When the program is set, information for the program is stored in the storing section (step S4).

Then the system controller 12 determines, based on the program set in step S4, to which of the ensemble A and ensemble B the program belongs (step S5).

At first, a case where the system controller 12 determines that a program belonging to the ensemble A has been set is described below. In this case, as the system controller 12 is providing controls for fetching a one channel included in the ensemble A, the system controller 12 controls the RF tuner section 13 and the channel decoder 14 to receive the ensemble A. In other words, surface waves in the frequency band TerA for the ensemble A is fetched from the earth station 2. Further two satellite waves in the frequency bands Sat 1A and Sat 2A for the ensemble A from the artificial satellites 3a, 3b, and one satellite wave in the frequency band Sar1 (2)B for the other ensemble B are fetched. Then the system controller 12 executes the de-interleaving processing to generate the information for the ensemble A (step S6).

Then the system controller 12 outputs information for the fetched program to the output section based on the generated information for the ensemble A. With this output operation, the program is transmitted (step S7).

Next a case where the system controller 12 determines, in step 5, that a program belonging to the ensemble B has been set is described below. In this case, the system controller 12 has been providing controls for fetching a one channel included in the ensemble A, the system controller 12 executes for processing for switching from the ensemble A to the ensemble B (step S8). In other words, the state where the ensemble A is received is switched to the state where the ensemble B is received. With this control for switching, a surface wave in the frequency band TerB for the ensemble A is received from the earth station 2. Further the two satellite waves in the frequency bands Sat 1B and Sat 2B from the artificial satellites 3a, 3b for the ensemble B and one satellite waves in the frequency band Sat 1(2)B for the other ensemble B are fetched. Then the system controller 12 executes the processing for de-interleaving to generate the information for the ensemble B (step S9).

Then the system controller 12 transmits information for the fetched information based on the generated information for the ensemble B. With this output operation, the program is transmitted according to the necessary (step S10).

When a user performs an input operation in the input section for switching to other program included in other information, the operations as shown in FIG. 6 are carried out. Namely, the system controller 12 recognizes, in response to the input operation by the user and based on the signal from the input section, that a channel has been selected to set a specific program (step S11). Then the system controller 12 determines whether the selected program belongs to the same ensemble A or B to which the program having been transmitted up to the time of selection or not, and also determines whether switching between the ensemble A and ensemble B is required or not (step S12).

In step S12, when it is determined that the newly selected program belongs to the same ensemble A or B to which the previous program belongs and switching between the ensembles A and B is not necessary, the system controller 12 makes the output section output the selected program. With this output operation, the selected program is transmitted according to the necessity (step S13).

On the other hand, when it is determined that the selected program belongs to the ensemble A or B different from that to which the previous program belongs and that switching between the ensemble A and ensemble B is required, the system controller executes the processing for switching between the ensembles A and B. Namely, the frequency band for electric waves to be received from the earth station 2 and from the artificial satellites 3a and 3b is switched to a new one. Then the selected program included in the ensemble A or ensemble B required after switching is transmitted to the output section according to the necessity (step S14).

As described above, once the processing for de-interleaving in step S6 and step S9 shown in FIG. 5 is executed for buffering, even when it is required to carry out switching between the ensembles A and B in response to a request for switching programs, time delay for switching is not required, and the time required until a new program is transmitted in response to the request for switching can be shortened.

When a number of programs are provided like in the embodiment above, the programs are divided to the ensemble A and ensemble B. Because of this configuration, work load for signal transmission can be reduced. Then, with this configuration, the same ensembles A and B are received from the earth station 2 and from the artificial satellites 3a, 3b respectively. Because of this feature, even in an area where, for instance, electric waves from the earth station 2 do not reach and can not be received, or where the electric waves from the artificial satellites 3a, 3b are shielded and can not be received, a desired program can be received without fail. When the plurality of ensembles A and B are received, in addition to the ensembles A or B including a program to be fetched, also other ensemble B or A is received. Therefore, it is required to execute the processing for de-interleaving only once like in the case where the processing for de-interleaving is executed to the totally 6 sections, namely the demodulating sections for demodulating signals for the ensembles A and B included in the surface wave and demodulating sections for demodulating signals for ensembles A and B from the two artificial satellites, and the time required until transmission of a new program is started can be shortened even when switching between the ensembles A and B is necessary.

Further the 6 demodulating sections for demodulating 6 broadcasts are not always required, and the same effect can be achieved even with four demodulating sections, so that the system configuration can be simplified with the producibility improved and the cost reduced. Namely it is conceivable that all of the electric waves in six frequency bands in all for two groups of information are fetched and demodulated to eliminate the troubles caused by the time interleave. With this configuration, however, the processing load becomes larger, and also such problems as the apparatus size increase and increase of consumed power may occur. To evade the problems, in the embodiment described above, only four demodulating sections are employed for eliminating the troubles caused by the time interleave to simplify the configuration.

With the configuration described above, the same ensembles A and B are received from the two artificial satellites 3a and 3b respectively. Namely, in addition to the ensembles A and B received from the earth station 2 and other ensembles B and A for shortening the time until transmission of a new program is started, also totally four electric waves including those for the ensembles A and B received from the earth station 2 and the same ones for the ensembles A and B are received. Because of this configuration, a desired program can be received in stable conditions even with the configuration in which the receiving apparatus is mounted on a moving vehicle.

Further with the satellite wave tuner section 22 in the RF tuner section 13 for receiving electric waves, in addition to the ensembles A and B to be fetched, also other ensembles B and A are received by processing electric waves from the artificial satellites 3a and 3b as shown in FIG. 4. Therefore, with the simple configuration, both of different ensembles A and B can smoothly be fetched and transmitted within a short period of time.

### SECOND EMBODIMENT

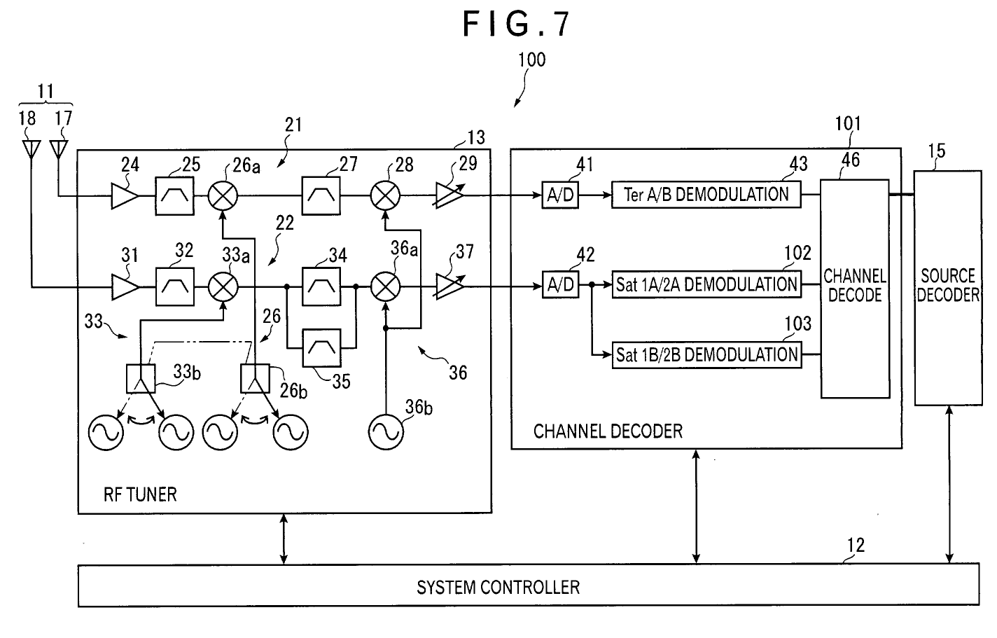

Next another embodiment of the communication system according to the present invention is described below with reference to the related drawings. This second embodiment is an example of a fixed type of receiving apparatus in which the receiving apparatus is not mounted in a vehicle as described above in the first embodiment and shown in FIG. 1 to FIG. 6, but is installed on an ordinary residence or the like. In this second embodiment, the same reference numerals are assigned to the same components as those in the first embodiment and the detailed description is omitted herein. FIG. 7 is a block diagram showing a receiving apparatus according to the second embodiment.

### Configuration of the Receiving Apparatus

In FIG. 7, the reference numeral 100 indicates a receiving apparatus, and the receiving apparatus 100 is laced in an ordinary residence, a store, an office or the like. This receiving apparatus 100 comprises a receiving antenna 11 similar to that used in the first embodiment, an input section not shown, a system controller 12, an RF tuner section 13, a source decoder 15, and a channel decoder 101.

The channel decoder 101 comprises A/D (analog/digital) converters 41, 42, a surface wave demodulating section 43 which is a first demodulating section as a surface wave fetching section, a satellite dominant wave demodulating section 102 which is a second demodulating section as a satellite dominant wave fetching section, a satellite complementary wave demodulating section 103 which is a third demodulating section as a satellite complementary fetching section; and a channel decoding section 46 as an extracting section. In other words, the channel decoder 101 demodulates, different from the channel decoder 14 according to the first embodiment shown in FIG. 1 to FIG. 6 in which three waves are demodulated by the satellite dominant wave demodulating sections 44a, 44b and the satellite complementary wave demodulating section 45, two electric waves with the satellite dominant wave demodulating section 102 and the satellite complementary wave demodulating section 103.

The satellite dominant wave demodulating section 102 corresponds to either one of the two artificial satellites 3a, 3b, demodulates the digital signals converted by the A/D converter 42, and fetches the ensembles B and A. Namely, the satellite dominant wave demodulating section 102 fetches the same ensembles A and B as those fetched by the surface wave demodulating section 43 from either one of the artificial satellites 3a, 3b. The ensembles A and B demodulated are transmitted to the channel decoding section 46.

The satellite complementary demodulating section 103 corresponds to either one of the two artificial satellites 3a, 3b, demodulates the digital signals converted by the A/D converter 42, and fetches the ensembles A and B. Namely the satellite complementary demodulating section 103 fetches other ensembles B and A which are not the ensembles A and N fetched by the surface wave demodulating section 43 from either one of the artificial satellites 3a, 3b. The demodulated signals for the other ensembles B and A are transmitted to the channel decoding section 46.

In the processing for demodulation by the satellite dominant wave demodulating section 102 and the satellite complementary wave demodulating section 103, either electric wave having higher amplitude may be received according to the amplitudes of the electric waves received from the artificial satellites 3a, 3b. The present invention is not limited to the configuration in which demodulation is carried out based on the electric waves from the same artificial satellites 3a, 3b, the configuration is allowable in which electric waves from other artificial satellites 3a, 3b are received and demodulated to fetch different ensembles A and B.

### Operations of the Communication Systems

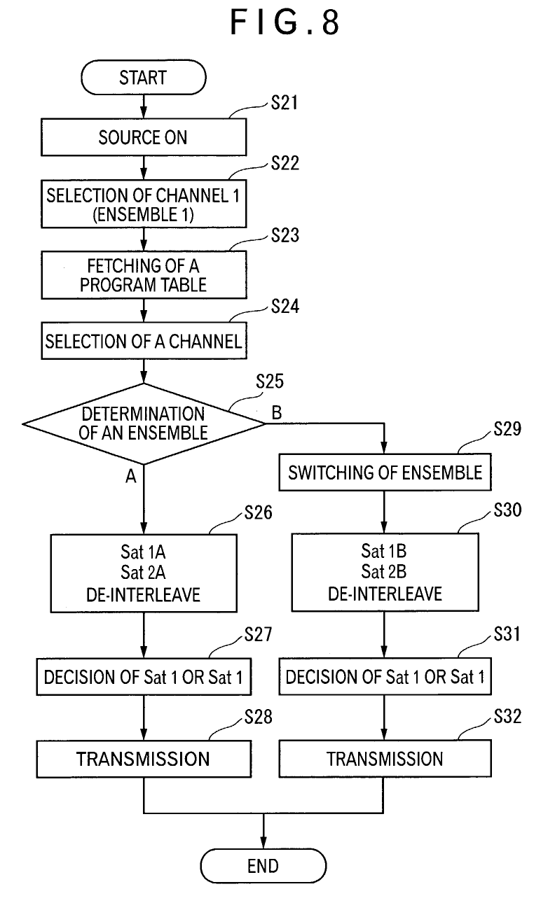

Operations for transmission of information in the communication system making use of the receiving apparatus shown in FIG. 7 are described below with reference to the related drawings. FIG. 8 is a flow chart showing operations for fetching program information in the receiving apparatus.

When a power supply unit is turned ON by a user and power supply is started (step S21), the system controller 12 sets a one channel included in the ensemble A which is the first program information, namely the program table information like in the first embodiment shown in FIG. 1 to FIG. 6 (step S22). Further, the system controller 12 receives the electric waves transmitted from the earth station 2 as well as the artificial satellites 3a, 3b like in the first embodiment, and the received electric waves are processed by the RF tuner section 13 and the channel decoder 101 according to the necessity to fetch the program table information for a one channel (step S23). The fetched program table information is stored in a storing section of the system controller 12.

The system controller 12 determines whether a specific program has been selected and set in response to an input operation in the input section by a user or not. When the system controller 12 recognizes, like in the first embodiment, that a specific program has been selected, the system controller 12 stores and sets the information for the selected program in the storing section (step S24).

Further the system controller 12 determines, like in the first embodiment, based on the program set in the step S24, to which of the ensembles A and B the selected program belongs (step S25). In this step S25, when it is determined that the selected program belongs to the ensemble A, as already a one channel for the ensemble A has been fetched, the ensemble A is received as it is.

Namely, a surface wave in the frequency band TerA for the ensemble A from the earth station 2 is fetched. Further the waveforms processed in the frequency bands Sat 1A and Sat 1B for the ensemble A respectively are processed and fetched by the satellite dominant wave demodulating section 102 based on the electric waves from the artificial satellites 3a, 3b respectively. Then the system controller 12 executes the processing for de-interleaving to generate the information for the ensemble A (step S26).

Then the system controller 12 executes the processing for deciding which of the artificial satellites 3a and 3b the electric wave is to be received by checking the receiving state of the signals from the artificial satellites 3a, 3b and also by comparing the amplitudes of the signals from the artificial satellites 3a, 3b to each other (step S27). Then the system controller 12 provides controls for making the output section transmit the information for the program fetched based on the information for the generated ensemble A (step S28).

On the other hand, instep S25, when it is determined that the program set in step S24 belongs to the ensemble B, as a one channel for the ensemble A including the previous program has been fetched, the processing for switching to the ensemble B is executed (step S29). With the control for switching in this step S29, the surface wave in the frequency band TerB for the ensemble A is fetched from the earth station 2. Further based on the electric waves from the artificial satellites 3a, 3b, the waveforms processing in the frequency bands Sat 1B and Sat 2B for the respective ensemble B are processed and fetched in the satellite dominant wave demodulating section 102. Then the system controller 12 executes the processing for de-interleaving to generate the information for the ensemble B (step S30).

Then the system controller 12 checks the receiving states from the artificial satellites 3a, 3b, namely compares amplitudes of the electric waves from the artificial satellites 3a, 3b, and executes the processing for deciding from which of the artificial satellites 3a and 3b the electric wave is to be received (step S31). Then the system controller 12 provides controls for having the information for the fetched program transmitted from the output section based on the generated information for the ensemble B (step S32).

As described above, when the receiving apparatus 100 is of the fixed type, the case where an electric wave from either one of the artificial satellites 3a, 3b can not be received because of movement of the receiving apparatus never occurs, so that it is necessary only to receive one surface wave and one satellite wave for fetching the ensembles A and B. Because of this feature, the configuration can be simplified more as compared to the embodiment shown in FIG. 1 through FIG. 6.

In the second embodiment shown in FIG. 7 and FIG. 8, as electric waves are received from the two artificial satellites, the ensembles A and B are fetched from the electric waves respectively, and then from which of the artificial satellites 3a, 3b is to be received is decided. Because of this configuration, the more excellent receiving state is insured, and information can be transmitted in the stable state.

In the case of the fixed type of receiving apparatus, it is required only to receive one satellite wave, and therefore the configuration is allowable in which not two artificial satellites, but only one artificial satellite is utilized. In this case, it is not necessary to decide from which of the artificial satellites 3a, 3b the electric wave is to be received, and therefore the processing efficiency can be improved with the configuration further simplified.

### THIRD EMBODIMENT

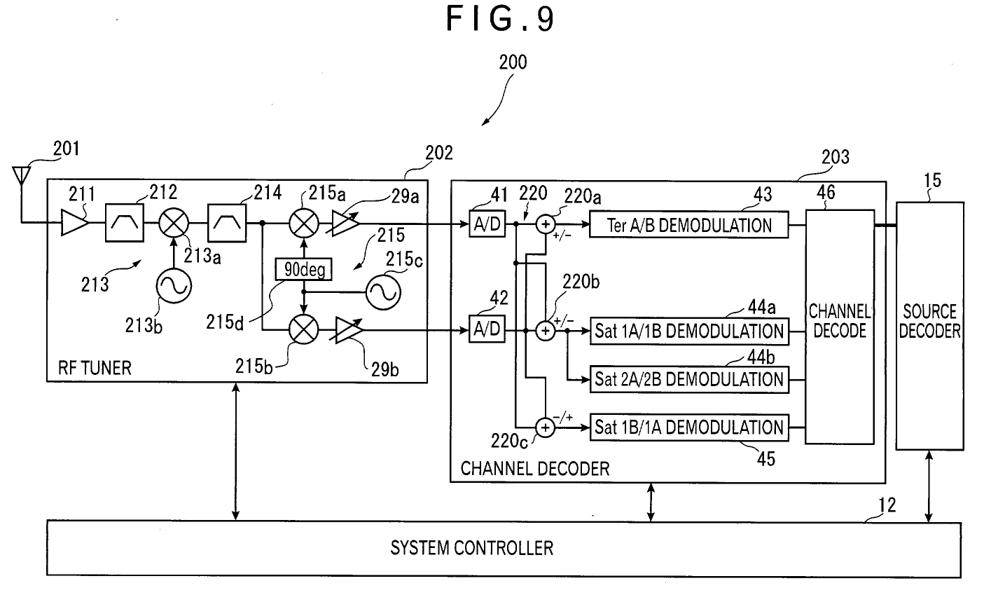

Then still another embodiment of the communication system according to the present invention is described with reference to the related drawings. This third embodiment is different from the first embodiment shown in FIG. 1 to FIG. 6 in that switching between the fetched ensembles A and B is executed, not by the RF tuner section 13, but a channel decoder. In this third embodiment, the same reference numerals are assigned to the same components as those in the first embodiment, and description thereof is omitted. FIG. 9 is a block diagram showing an receiving apparatus according to the third embodiment.

In FIG. 9, the reference numeral 200 indicates a receiving apparatus, and this receiving apparatus 200 is mounted on a movable body such as, for instance, a vehicle. This receiving apparatus 200 comprises an input section like that in the first embodiment and not shown herein, a system controller 12, a source decoder 15, a receiving antenna 201, and RF tuner section 202, and a channel decoder 203.

The receiving antenna 201 can receive both surface waves from the earth station 2 and electric waves from the artificial satellites 3a, 3b.

The RF tuner section 202 comprises a first amplifying circuit 211, a first filter 212, a first frequency converting circuit 213, a second filter 214, a second frequency converting circuit 215, and second amplifying circuits 29a, 29b.

The first amplifying circuit 211 is connected to the receiving antenna 201. The first amplifying circuit 211 amplifies the electric waves received by the receiving antenna 201.

The first filter 212 executes the processing for attenuating, of the signals amplified by the first amplifying circuit 211, signals other than those in the frequency bands for the electric waves from the earth station 2 and the artificial satellites 3a, 3b. The frequency bands with the signals therein attenuated is within the range of the frequency bands TerA and TerB for the two ensembles A and B and the frequency bands Sat 1(2)A and Sat 1(2) B for the two ensembles A and B transmitted from the two artificial satellites 3a, 3b respectively.

The first frequency converting circuit 213 converts the signals fetched by the processing for attenuation by the first filter 212 to prespecified intermediate frequency signals. This first frequency converting circuit 213 comprises a first mixing circuit 213a and a first local oscillating circuit 213b. The first mixing circuit 213a efficiently converts high frequency waves to intermediate frequency signals to reduce noises. The first local oscillating circuit 213b is a clamping circuit with high stability based on the Colpittz oscillator which is stable and has the simple circuit configuration. The first local oscillating circuit 213 is controlled so that the oscillation frequency thereof will be kept constant based on a reference frequency now shown.

The second filter 214 executes the processing for attenuating unnecessary signals among the intermediate frequency waves generated after the processing in the first frequency converting circuit 213.

The second frequency converting circuit 215 comprises two sets of mixing circuits 215a, 215b, a second local oscillation circuit 215c, and a phase angle converting section 215d. The mixing circuits 215a, 215b efficiently convert the electric waves to prespecified intermediate frequency signals respectively to reduce noises. The second local oscillation circuit 215c is controlled based on a reference frequency not shown so that the oscillation frequency will be kept constant. The phase angle converting section 215d controls a phase angle so that the phase angles introduced into the mixing circuits 215a, 215b are off by 90 degrees from each other.

The second amplifying circuits 29a, 29b have a volume not shown respectively like in the first embodiment, amplifies signals converted by the second surface wave frequency converting circuit 28 to prespecified intermediate frequency signals, and transmit the converted signals to the channel decoder 203 respectively.

The channel decoder 203 comprises A/D converters 41, 42, a switching section 220, a surface wave demodulating section 43, satellite dominant wave demodulating sections 44a, 44b, a satellite complementary demodulating section 45, and a channel decoding section 46.

The switching section 220 executes switching between the ensemble A and ensemble B executes switching each as a group of information demodulated by the surface wave demodulating section 43, satellite dominant wave demodulating sections 44a, 44b, and satellite complementary wave demodulating section 45 to fetch the ensembles A or B set in response to an input operation by a user. This switching section 220 comprises a surface wave switching section 220a, a first satellite wave switching section 220b, and a second satellite switching section 220c. The surface wave switching section 220, first satellite wave switching section 220b, and second satellite switching section 220c are connected to the A/D converters 41 and 42 respectively.

Connected to the surface wave switching section 220a is the surface wave demodulating section 43. The surface wave switching section 220a selectively transmits, of the digital signals transmitted from the A/D converters 41, 42, either one of the digital signals corresponding to the ensembles A and B included in the surface wave to the surface wave demodulating section 43. This surface wave switching section 220a is controlled by the system controller 12 which also functions as a setting section setting the ensembles A and B based on the signal from the input section in response to an input operation by the user. With this control, the surface wave switching section 220a switching, of the digital signals, that corresponding to either one of the ensembles A and B, and selectively transmits the digital signal to the surface wave demodulating section 43.

Connected to the first satellite wave switching section 220b are the satellite dominant wave demodulating sections 44a and 44b respectively. Then the first satellite wave switching section 220b transmits, of the digital signals transmitted from the A/D converters 41, 42, either one of the digital signals corresponding to the ensembles A and B included in the satellite wave. This first satellite switching section 220b is controlled by the system controller 12, like the surface wave switching section 220a, in synchronism to switching of the surface wave switching section 220a. With this control, digital signals corresponding to the same ensembles A and B as those transmitted from the surface wave switching section 220a are transmitted.

Connected to the second satellite wave switching section 220c is the satellite complementary wave demodulating section 45. The second satellite wave switching section 220c transmits, of the digital signals transmitted from the A/D converters 41, 42, the digital signal other than that corresponding to the ensemble A or ensemble B included in the satellite waves to the satellite complementary wave demodulating section 45 respectively. This second satellite wave switching section 220 is controlled by the system controller 12 in synchronism to switching of the surface wave switching section 220a and the first satellite wave switching section 220b. With this control, the digital signal corresponding to other ensemble B or A different from the ensemble A or B transmitted from the surface wave switching section 220a and the second satellite wave witching section 220b is transmitted.

Then, like in the first embodiment, the user turned on power to receive a one channel and fetch desired table information. Then a specified program desired by the user is set, and the electric waves received from the earth station 2 and from the artificial satellites 3a, 3b are subjected to quadrature demodulation in the RF tuner section 202. Then the system controller 12 determines the ensemble A or B based on the set program and executes switching between the ensembles A and B according to the necessity. In other words, of the mixed signals for the ensembles A and B transmitted from the RF tuner section 202, only the signal for ensemble A or B determined as described above is transmitted to the surface wave demodulating section 43 and to the satellite dominant wave demodulating sections 44a, 44b to be demodulated therein, and also only the other signal for the ensemble B or A different from the ensemble A or B determined as described above is transmitted to the satellite complementary wave demodulating section 45 to be demodulated and subjected to the processing for de-interleaving therein. Because of this configuration, the time required until both different ensembles A or B are fetched and transmitted can easily be shortened.

### FOURTH EMBODIMENT

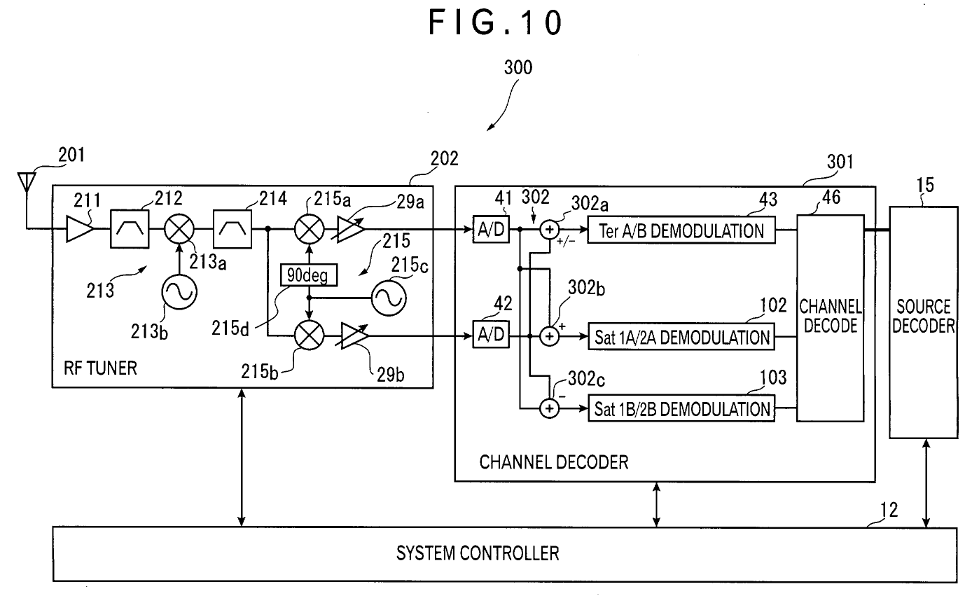

Another embodiment of the communication system according to the present invention is described with reference to the related drawings. The fourth embodiment is another example of the fixed type of receiving apparatus installed not in a vehicle like in the third embodiment shown in FIG. 9, but in an ordinary residence or the like. Namely this fourth embodiment is different from the second embodiment in that switching between the ensembles A and B is performed, not by the RF tuner section 13, but by a channel decoder. In the fourth embodiment, the same reference numerals are assigned to the same components as those in the second and third embodiments, and detailed description thereof is omitted herein. FIG. 10 is a block diagram showing the receiving apparatus according to the fourth embodiment.

In FIG. 10, the reference numeral 300 indicates a receiving apparatus, and this receiving apparatus 300 is installed, for instance, in an ordinary residence, a store, an office or the like in use. This receiving apparatus 300 comprises a receiving antenna 201 similar to that in the third embodiment, an input section not shown, a system controller 12, an RF tuner section 202, a source decoder 15, and a channel decoder 301.

The channel decoder 301 comprises A/D (analog/digital) converters 41, 42, a witching section, a surface wave demodulating section 43 as a surface wave fetching section, a satellite dominant wave demodulating section 102 and a satellite complementary wave demodulating section 103 like those in the second embodiment, and a channel decoding section 46. Namely the channel decoder 301 is based on the configuration in which, different from the configuration in which three electric waves are demodulated by the satellite dominant wave demodulating sections 44a, 44b and the satellite complementary demodulating section 45 in the channel decoder 203 in the third embodiment, two electric waves are demodulated by the satellite dominant wave demodulating section 102 and the satellite complementary wave demodulating section 103.

The switching section 302 executes switching between the ensembles A and B to be demodulated by the surface wave demodulating section 43, satellite dominant wave demodulating section 102, and satellite complementary wave demodulating section 103 to fetch the ensemble A or B set in response to an input operation by the user. This switching section 302 comprises a surface wave switching section 302a, a first satellite wave switching section 302b, and a second satellite wave switching section 302c. The surface wave switching section 302, a first satellite wave switching section 302b, and second satellite wave switching section 302c are connected to the A/D converters 41, 42 respectively.

Connected to the surface wave switching section 302a is the surface wave demodulating section 403. Like the surface wave switching section 220a according to the third embodiment, the surface wave switching section 302a selectively transmits, of the digital signals transmitted from the A/D converters 41, 42, the digital signal corresponding to the ensemble A or B included in the surface wave to the surface wave demodulating section 43. This surface wave switching section 220a is controlled by the system controller 12 also functioning as a setting section setting the ensemble A or B according to the signal from the input section in response to an input operation by the user. With this control, the surface wave switching section 220a switching the digital signal corresponding to either one of the ensembles A and B included in the surface wave according to the necessary, and selectively transmits the signal to the surface wave demodulating section 43.

Connected to the first satellite wave switching section 302b is the satellite dominant wave demodulating section 102. The first satellite wave switching section 302b transmits, of the digital signals transmitted from the A/D converters 41, 42, the digital signal corresponding to the ensemble A included in the satellite wave to the satellite dominant wave demodulating section 102. Namely, the first satellite wave switching section 302b selects and transmits only the digital signal corresponding to the ensemble A without executing the switching operation under controls by the system controller 12.

Connected to the second satellite wave switching section 302c is the satellite complementary wave demodulating section 45. The second satellite wave switching section 302c transmits, of the digital signal transmitted from the A/D converters 41, 42, the digital signal corresponding to the ensemble B included in the satellite wave. Namely, the second satellite wave switching section 302c selects and transmits only the digital signal corresponding to the ensemble B without executing the switching operation under controls by the system controller 12.

Like in the second embodiment, a user turns on power to receive a one channel to receive and fetch the program table information. When the user sets a desired program, the electric waves from the earth station 2 and the artificial satellites 3a, 3b are subjected to qaudrature demodulation in the RF tuner section 202. Then the system controller 12 determines the ensemble A or B based on the program set as described above, and executes switching between the ensembles A and B according to the necessity by controlling the switching section 302. Namely, of the mixed signals for the ensembles A and B transmitted from the RF tuner section 202, only the signal for ensemble A or B determined as described above is transmitted to the surface wave demodulating section 43 for demodulation. Further the system controller 12 transmits only the signal for the ensemble A to the satellite dominant wave demodulating section 102 for demodulation, and also transmits only the signal for the ensemble B to the satellite complementary wave demodulating section 103 for demodulating signals to be de-interleaved therein. Because of this feature, the time required until both of the different ensembles A and B are fetched and transmitted can easily be shortened with the simple configuration.

### VARIANTS EMBODIMENT

The present invention is not limited to the embodiments described above, and includes the following variants within the scope of the present invention.

Namely, the above description assumes a case where the earth station 2 and the two artificial satellites 3a, 3b are used to fetch programs grouped into the two ensembles A and B, but this invention is not limited to this configuration, and three or more artificial satellites may be utilized, and a plurality of programs may be grouped into three or more ensembles. Further not only programs, but other types of information such as image data may be used. Namely the present invention is based on the configuration in which at least one surface wave and at least one satellite wave are received to eliminate troubles in receiving due to geographical conditions, and also the configuration is allowable in which a plurality of ensembles each including a plurality of information are set and the ensembles are switched according to the necessity.

Further the configuration for switching between the ensembles A and B is not limited to the RF tuner section 13, and the switching may be executed, for instance, the channel decoders 203, 301.

In addition to the RF tuner section 13, 202 and the channel decoders 14, 203, 301, other components each functioning similarly may be used for switching.

The specific structure or the procedure for recognizing generation of abnormality may be modified on the condition that the objects of the present invention are achieved.

What is claimed is:

1. A receiving apparatus for receiving a plurality of groups of information each group including a plurality of different information, said plurality of groups transmitted as electric waves in different frequency bands from an earth station and a plurality of artificial satellites respectively, fetching a specified group of information by demodulating the received electric wave, and fetching the information included in the group of information, said receiving apparatus comprising:
a satellite wave fetching section for fetching any one of said plurality of groups of information by demodulating any one of the electric waves received from said earth station;
a satellite dominant wave fetching section for fetching, by demodulating the electric wave received from at least one of said artificial satellites in a frequency band corresponding to the same group of information as that fetched by said satellite wave fetching section, the same group of information; and
a satellite complementary wave fetching section for fetching, by demodulating the electric waves received from at least one of said artificial satellites in frequency bands corresponding to the groups of information other than that fetched by said satellite dominant wave fetching section, the other groups of information.

2. The receiving apparatus according to claim 1, wherein said receiving apparatus can be mounted in a movable body capable of moving around, and said satellite dominant wave fetching section fetches the same group of information as that fetched by the surface wave fetching section based on the electric waves received from at least two or more artificial satellites among a plurality of artificial satellites.

3. The receiving apparatus according to claim 1, wherein said receiving apparatus is placed at a fixed position in the unmovable manner at least during the period of receiving and demodulating an electric wave, and the satellite dominant wave fetching section fetches the same group of information as that fetched by the surface wave fetching section based on the electric wave received from at least any one of the plurality of artificial satellites.

4. The receiving apparatus according to claim 1 further comprising a tuner section in turn comprising a surface wave filter for attenuating signals included in the electric waves received from the earth station in the frequency bands corresponding to the groups of information other than that to be fetched, a satellite dominant wave filter for attenuating signals included in the electric waves received from at least any one of the plurality of artificial satellites in the frequency bands corresponding to the groups of information other than that to be fetched, and a satellite complementary wave filter for attenuating signals from said plurality of satellites in frequency bands other than that of the group of information to be fetched, wherein the surface wave fetching section fetched groups of information by demodulating signals processed by the surface wave filter in said tuner section; the satellite dominant wave fetching section fetches said groups of information by demodulating the signals processed by the satellite dominant wave filter in said tuner section; and the satellite complementary wave fetching section fetches the groups of information other than said group of information by demodulating the signals processed by the satellite complementary filter in said tuner section.

5. The receiving apparatus according to claim 1 further comprising:
a setting section for setting a group of information; and
a switching section for switching a frequency band to be demodulated in the electric waves received from the earth station and the plurality of artificial satellites in response to the group of information set in the setting section.

6. The receiving apparatus according to claim 1, wherein a number of the artificial satellites is two and also a number of groups of information is two.

7. A receiving apparatus comprising:
a receiving section for receiving a first broadcast, a second broadcast, and a third broadcast each broadcasting first information in a different frequency band respectively, and also receiving a fourth broadcast, a fifth broadcast, and a sixth broadcast each broadcasting second information with the contents different from those of said first information in a different frequency band respectively;
a first demodulating section for demodulating said first and fourth broadcasts;
a second demodulating section for demodulating said second and fifth broadcasts; and
a third demodulating section for demodulating said third and sixth broadcasts, wherein said first demodulating section, second demodulating section, and third demodulating section execute demodulation simultaneously, said third demodulating section demodulates said sixth broadcasts when said second demodulating section demodulates said second broadcast, and said third demodulating section demodulates said third broadcast when said second demodulating section demodulates said fifth broadcast.

8. The receiving apparatus according to claim 7, wherein each of said first information and said second information includes a group including a plurality of programs for broadcasting respectively, said receiving apparatus further comprising:
a selecting section for selecting one program from the plurality of programs included in the first information and the second information;
a switching section for selecting said first demodulating section or one demodulating section of said second demodulating section and said third demodulating section according to the receiving conditions; and
an extracting section for extracting and outputting said one program selected by said selecting section.

9. The receiving apparatus according to claim 8,
wherein, said extracting section extracts output from either one demodulating section, which demodulates said second information, of the said second demodulating section and said third demodulating section, and said first demodulating section demodulates said fourth broadcast and at the same time demodulation by one demodulating section, which demodulates said first information, of said second demodulating section and said third demodulating section is maintained, in a case said selecting section makes a selection for said extracting section to extract one program included in said second information while said extracting section is extracting another program included in said first information.

10. A receiving apparatus comprising:
a receiving section for receiving a first broadcast, a second broadcast, and a third broadcast each broadcasting first information in a different frequency band respectively, and also receiving a fourth broadcast, a fifth broadcast, and a sixth broadcast each broadcasting second information with the contents different from those of said first information in a different frequency band respectively;
a first demodulating section for demodulating said first and fourth broadcasts;
a second demodulating section for demodulating said second and third broadcasts; and
a third demodulating section for demodulating said fifth and sixth broadcasts, wherein said first demodulating section, second demodulating section, and third demodulating section execute demodulation simultaneously.

11. The receiving apparatus according to claim 10, wherein each of said first information and said second information includes a group including a plurality of programs for broadcasting respectively, said receiving apparatus further comprising:
a selecting section for selecting one program from the plurality of programs included in said first information and said second information;
a switching section for selecting one broadcast, which is demodulated by said second demodulating section and said third demodulating section respectively, from said first broadcast and said second broadcast, and for selecting said first demodulating section or one demodulating section of said second demodulating section and said third demodulating section, according to the receiving conditions; and
an extracting section for extracting and outputting said one program selected by said selecting section.

12. The receiving apparatus according to claim 11,
wherein said extracting section extracts output from said third demodulating section, said first demodulating section demodulates said fourth broadcast, and demodulation of said second broadcast or third broadcast by said second demodulating section is maintained, in a case said selecting section makes a selection for said extracting section to extract one program included in said second information while said extracting section is extracting another program included in said first information.

13. A receiving method of receiving a plurality of groups of information each group including a plurality of different information, said plurality of groups transmitted as electric waves in different frequency bands from an earth station and a plurality of artificial satellites respectively, fetching a specified group of information by demodulating the received electric wave, and fetching the information included in the group of information, said method comprising the steps of:
fetching any one of said plurality of groups of information by demodulating, of the electric waves received from said earth station, the electric wave in any one frequency band;
fetching, by demodulating the electric waves received from at least any one of said plurality of artificial satellites in a frequency band corresponding to the same group of information as that fetched based on the electric wave received from said earth station, said same group of information; and
fetching said other groups of information by modulating, of the electric waves received from at least any one of said artificial satellites, those in the frequency band corresponding to the groups of information other than that fetched based on the electric wave received from said earth station.

14. The receiving method according to claim 13 applicable to a movable body capable of moving around, wherein the same group of information as that fetched from the electric wave received from the earth station is fetched from the electric waves received from at least two or more of a plurality of artificial satellites.

15. The receiving method according to claim 13 applicable to the configuration in which the receiving body can not move at least while the receiving body receives and demodulates an electric wave, wherein the same group of information as that fetched from the electric wave received from the earth station is fetched from the electric wave received from any one of said plurality of artificial satellites.

16. The receiving method according to claim 13 further comprising the steps of:
attenuating signals other than those in the frequency bands for the group of information fetched from the electric wave from the earth station to fetch said group of information by demodulating the signal fetched through this processing for attenuation;
attenuating signals other than those in the frequency band for said group of information fetched from the electric waves received from at least any of a plurality of artificial satellites and demodulating the signals fetched through this attenuation to fetch the same group of information as said group of information; and
attenuating signals other than those in the frequency bands for the groups of information other than that to be fetched in the electric waves received from at least any one of the artificial satellites.

17. The receiving method according to claim 13, wherein a frequency band to be demodulated in the electric waves received from the earth station and a plurality of artificial satellites is switched according to the group of information set to be fetched to fetch said group of information as an object for fetching and also the groups of information other than said object group of information.

18. The receiving method according to claim 13, wherein two groups of information are fetched based on the electric waves received from two artificial satellites.

19. A receiving program for having the receiving method according to claim 13 executed.

20. A recording medium with the recording program recorded therein, wherein said receiving program is recorded in the state readable to a computing device.

21. A communication system comprising:
an earth station for transmitting a plurality groups of information each including a plurality of different information as electric waves in different frequency bands corresponding to the groups of information respectively;
a plurality of artificial satellites transmitting said plurality of groups of information as electric waves in different frequency bands respectively; and
the receiving apparatus according to claim 1.
